(19) United States
(12) Patent Application Publication
(10) Pub. No.: US 2026/0176997 A1
(43) Pub. Date: Jun. 25, 2026

(54) CONTROLLER FOR INTERNAL COMBUSTION ENGINE

(71) Applicant: TOYOTA JIDOSHA KABUSHIKI KAISHA, Aichi-ken (JP)

(72) Inventor: Tomokazu AKUTSU, Nagakute-shi (JP)

(21) Appl. No.: 19/369,360

(22) Filed: Oct. 27, 2025

(30) Foreign Application Priority Data
Dec. 23, 2024 (JP) 2024-226404

(51) Int. Cl. F01N 11/00; B01D 46/00; B01D 46/44; B01D 46/46; F01N 3/023

(52) U.S. Cl. CPC F01N 11/00; B01D 46/0086; B01D 46/446; B01D 46/46; F01N 3/023; B01D 2279/30; F01N 2550/04

(57) ABSTRACT

An internal combustion engine includes a filter that is provided in an exhaust passage and traps particulate matter in an exhaust gas, and a pressure sensor that detects pressure information including a pressure on an exhaust upstream side of the filter. A controller executes an accumulation amount calculation process of calculating an accumulation amount of the particulate matter accumulated in the filter based on the pressure information. The accumulation amount calculation process includes correcting the accumulation amount of the particulate matter in accordance with a degree of variation in the accumulation amount of the particulate matter along an exhaust flow direction of the filter.

### CROSS-REFERENCE TO RELATED APPLICATIONS

This application is based upon and claims the benefit of priority from Japanese Patent Application No. 2024-226404, filed on Dec. 23, 2024, the entire contents of which are incorporated herein by reference.

### BACKGROUND

### 1. Field

The present disclosure relates to a controller for an internal combustion engine.

### 2. Description of Related Art

JP2019-105181A discloses an internal combustion engine equipped with a filter for trapping particulate matter contained in the exhaust gas, the filter being disposed in an exhaust passage. A control device calculates an accumulation amount of particulate matter accumulated on the filter based on a differential pressure across the filter, which serves as pressure information.

It is desirable that the accumulation amount of particulate matter calculated based on the pressure information be calculated with high accuracy.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a controller is configured to control an internal combustion engine. The internal combustion engine includes a filter that is provided in an exhaust passage and traps particulate matter in an exhaust gas, and a pressure sensor that detects pressure information including a pressure on an exhaust upstream side of the filter. The controller includes processing circuitry. The processing circuitry is configured to execute an accumulation amount calculation process of calculating an accumulation amount of the particulate matter accumulated in the filter based on the pressure information. The accumulation amount calculation process includes correcting the accumulation amount in accordance with a degree of variation in the accumulation amount of the particulate matter along an exhaust flow direction of the filter.

Other features and aspects will be apparent from the following detailed description, the drawings, and the claims.

### BRIEF DESCRIPTION OF THE DRAWINGS

FIG. 1 is a schematic diagram showing an internal combustion engine in which a controller according to an embodiment is employed.

FIG. 2 is a flowchart showing a procedure of an accumulation amount calculation process executed by the controller according to the embodiment.

FIG. 3 is a graph showing relationships among the degree of variation of accumulation amount, an accumulation density counter, a correction factor, and a differential pressure.

FIG. 4 is a flowchart showing a procedure of an index value calculation process executed by the controller according to the embodiment.

FIG. 5 is a flowchart showing a procedure of processes executed by the controller according to the embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

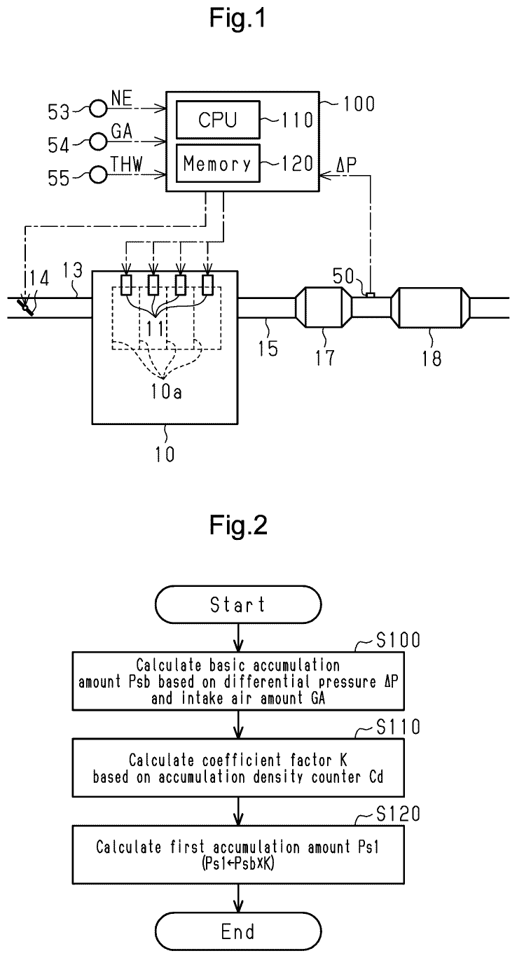

A controller for an internal combustion engine according to an embodiment will now be described with reference to FIGS. 1 to 5. In the present embodiment, the upstream side in the flow direction of the exhaust gas is referred to as upstream, and the downstream side in the flow direction of the exhaust gas is referred to as downstream.

### Configuration of the Internal Combustion Engine

As shown in FIG. 1, an internal combustion engine 10 using gasoline as fuel includes multiple cylinders 10a. An intake passage 13 is connected to an intake port of each of the cylinders 10a. The intake passage 13 includes a throttle valve 14 that adjusts an intake air amount.

The combustion chambers of the cylinders 10a each include a fuel injection valve 11. Then, in the combustion chamber of each of the cylinders 10a, an air-fuel mixture of the air taken in through the intake passage 13 and the fuel injected from the fuel injection valve 11 is ignited by spark discharge and burned. Exhaust gas generated by the combustion of the air-fuel mixture in the combustion chamber is discharged to an exhaust passage 15 connected to an exhaust port of the internal combustion engine 10.

The exhaust passage 15 includes a three-way catalyst 17. The three-way catalyst 17 oxidizes hydrocarbon (HC) and carbon monoxide (CO) contained in the exhaust gas to produce water and carbon dioxide. The three-way catalyst 17 reduces nitrogen oxides (NOx) contained in the exhaust gas to produce nitrogen.

A gasoline particulate filter (hereinafter, referred to as GPF) 18 is provided in the exhaust passage 15 downstream of the three-way catalyst 17. The GPF 18 is a filter that collects particulate matter (hereinafter referred to as PM) in the exhaust gas.

The controller 100 includes electronic components such as a CPU 110 and a memory 120, and performs various controls of the internal combustion engine 10 by the CPU 110 executing a program stored in the memory 120.

The controller 100 receives detection signals from the various types of sensors. For example, a pressure sensor 50 is provided in the exhaust passage 15 at a location downstream of the three-way catalyst 17 and upstream of the GPF 18. The pressure sensor 50 detects pressure information including the pressure on the upstream side of the GPF 18. The pressure information is a differential pressure AP between the exhaust gas pressure EP on the upstream side of the GPF 18 and the atmosphere. A crank angle sensor 53 is provided near a crankshaft of the internal combustion engine 10, and an engine rotation speed NE of the internal combustion engine 10 is calculated based on a detection signal of the crank angle sensor 53. The internal combustion engine 10 is also provided with an air flow meter 54 that detects an intake air amount GA, and a coolant temperature sensor 55 that detects a coolant temperature THW that is a temperature of cooling water of the internal combustion engine 10.

The controller 100 controls fuel injection of the fuel injection valve 11, an opening degree of the throttle valve 14, and the like. Further, when the output required of the internal combustion engine 10 is 0, the controller 100 executes fuel cut to stop fuel injection from the fuel injection valve 11.

The controller 100 calculates a PM accumulation amount which is an amount of PM accumulated in the GPF 18. Then, various controls are performed based on the calculated PM accumulation amount. Examples of the various kinds of control include maintenance control of the GPF 18 and component protection control of the exhaust system. An example of the maintenance control is a regenerating control performed to burn and remove the PM accumulated in the GPF 18 when the PM accumulation amount becomes equal to or greater than a predetermined regenerating determination value A. An example of the maintenance control is notification control for notifying a warning for prompting maintenance in a repair shop in order to burn and remove the PM accumulated on the GPF 18 when the PM accumulation amount becomes equal to or larger than a predetermined excessive accumulation determination value B. An example of the component protection control of the exhaust system is excessive temperature rise suppression control that is executed to suppress an excessive temperature rise of the GPF 18 when the PM accumulation amount becomes equal to or greater than a predetermined protection determination value C. As the excessive temperature rise suppression control, for example, control for lowering the temperature of the exhaust gas may be mentioned.

### Accumulation Amount Calculation Process

The controller 100 executes an accumulation amount calculation process of calculating a first accumulation amount Ps1, which is the accumulation amount of PM accumulated in the GPF 18, based on the differential pressure AP, which is the pressure information.

FIG. 2 shows a procedure of an accumulation amount calculation process executed by the controller 100. The series of processes shown in FIG. 2 is realized by the CPU 110 executing a program stored in the memory 120 of the controller 100 at predetermined intervals. In the following description, the number of each step is represented by the letter S followed by a numeral.

In the series of processes shown in FIG. 2, first, the controller 100 acquires the current differential pressure AP and the current intake air amount GA, and calculates a basic accumulation amount Psb, which is a base value of the first accumulation amount Ps1, based on these values (S100). In the process of S100, the basic accumulation amount Psb is set to a larger value as the differential pressure AP increases.

If the process of S100 has been executed, next the controller 100 executes the process of S110.

In the process of S110, the controller 100 calculates a correction factor K based on the accumulation density counter Cd. The accumulation density counter Cd is an index value indicating the degree of variation in the accumulation amount of PM along the exhaust flow direction of the GPF 18. Hereinafter, the degree of variation in the accumulation amount of PM along the exhaust flow direction of the GPF 18 will be referred to as the degree of variation in the accumulation amount. When the value of the accumulation density counter Cd is small, the degree of variation in the accumulation amount is larger than when the value of the accumulation density counter Cd is large.

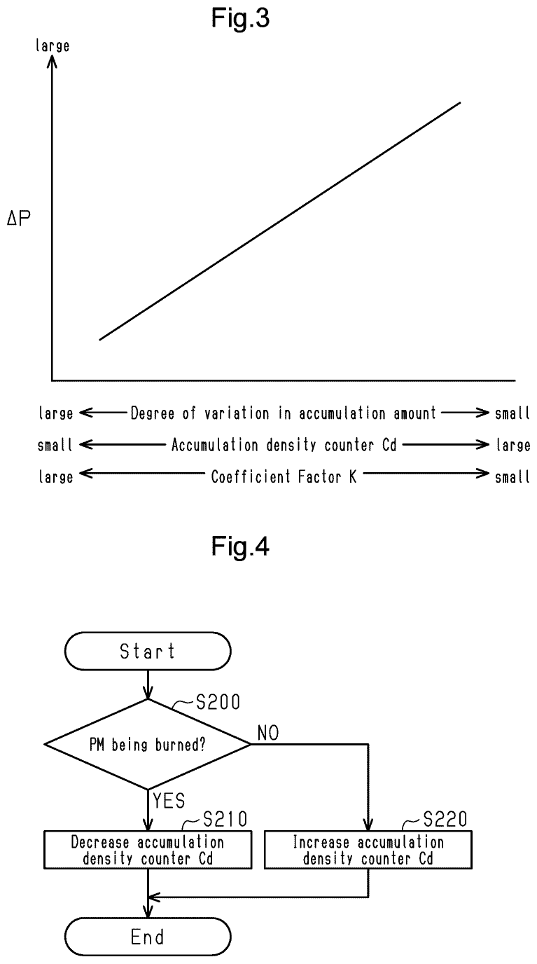

The correction factor K is a correction value for correcting the basic accumulation amount Psb. The value of the correction factor K is variably set in accordance with the value of the accumulation density counter Cd so as to become a smaller value the larger the value of the accumulation density counter Cd (see FIG. 3). The value of the correction factor K to be variably set is, for example, a value of 1 or more.

If the process of S110 has been executed, next the controller 100 executes the process of S120. In the process of S120, the controller 100 executes a process of substituting a value obtained by multiplying the basic accumulation amount Psb by the correction factor K for the first accumulation amount Ps1.

When the process of S120 is executed, the controller 100 ends the execution of this process in the current cycle.

### Calculation of Second Accumulation Amount

The controller 100 executes a process of calculating a second accumulation amount Ps2, which is an accumulation amount of PM accumulated in the GPF 18 and is calculated based on the operation state of the internal combustion engine 10.

For example, the controller 100 acquires the engine rotation speed NE, the charging efficiency η, and the coolant temperature THW. The charging efficiency η is calculated by the controller 100 based on the engine rotation speed NE and the intake air amount GA.

The controller 100 calculates a PM discharge amount Pa, which is an amount of PM discharged from the internal combustion engine 10 to the exhaust passage 15 per unit time, based on the engine rotation speed NE, the charging efficiency η, and the coolant temperature THW.

In addition, the controller 100 acquires the second accumulation amount Ps2, the GPF temperature T, and the intake air amount GA which are currently calculated, and calculates a PM burn-off amount Pb which is an amount of PM burned in the GPF 18 per unit time, based on the respective values. The GPF temperature T is the temperature of the GPF 18. The GPF temperature T is calculated by the controller 100 based on the engine rotation speed NE and the charging efficiency η. The GPF temperature T may be detected using, for example, a sensor.

Then, the controller 100 substitutes a value obtained by subtracting the PM burn-off amount Pb from the PM discharge amount Pa for the update amount APs. Therefore, when the PM discharge amount Pa is larger than the PM burn-off amount Pb, the update amount APs is a positive value, and when the PM burn-off amount Pb is larger than the PM discharge amount Pa, the update amount APs is a negative value.

Next, the controller 100 updates the second accumulation amount Ps2 by adding the update amount APs to the currently calculated second accumulation amount Ps2. Therefore, when the PM discharge amount Pa is larger than the PM burn-off amount Pb, the second accumulation amount Ps2 increases, whereas when the PM burn-off amount Pb is larger than the PM discharge amount Pa, the second accumulation amount Ps2 decreases. The second accumulation amount Ps2 is calculated by executing such a process.

### Accumulation Density Counter

The accumulation density counter Cd will be described with reference to FIGS. 3 and 4.

For example, when oxygen supply by fuel cut is started to the GPF 18 at a high temperature, the PM is burned in the upstream portion of the GPF 18. On the other hand, since oxygen is consumed by the combustion in the upstream portion, the burning of the PM is less likely to proceed in the downstream portion of the GPF 18. Therefore, when the PM is burned, the degree of variation in the amount of accumulation of the PM along the exhaust flow direction of the GPF 18 tends to increase. On the other hand, when the PM is not burned, the PM discharged from the internal combustion engine 10 is collected in the GPF 18, so the degree of variation in the amount of accumulation of the PM along the direction of flow of the exhaust gas in the GPF 18 tends to become smaller.

The present inventor has found that the relationship between the differential pressure AP and the PM accumulation amount tends to change in accordance with the degree of such variation in the accumulation amount. To be specific, as shown in FIG. 3, even when the actual PM accumulation amount in the GPF 18 is the same, the differential pressure AP tends to be smaller in the case where the degree of variation in the accumulation amount is large than in the case where the variation is small. Therefore, when the degree of variation in the accumulation amount is large, the calculated first accumulation amount Ps1 may be smaller than the actual accumulation amount compared to when the variation is small.

Therefore, the controller 100 of the present embodiment calculates the accumulation density counter Cd such that the value of the accumulation density counter Cd, which is an index value indicating the degree of variation in the accumulation amount, increases as the degree of variation in the accumulation amount decreases. The controller 100 corrects the first accumulation amount Ps1 such that the first accumulation amount Ps1 increases as the degree of variation in the accumulation amount increases by calculating the correction factor K such that the value of the correction factor K increases as the value of the accumulation-density counter Cd decreases.

FIG. 4 shows a procedure of an index value calculation process for calculating the accumulation density counter Cd. The series of processes shown in FIG. 4 is realized by the CPU 110 executing a program stored in the memory 120 of the controller 100 at predetermined intervals. The initial value of the accumulation density counter Cd is 0.

In the series of processes shown in FIG. 4, the controller 100 first determines whether PM is currently burned (S200). In the process of S200, for example, the controller 100 determines that PM is currently burned when the first accumulation amount Ps or the second accumulation amount Ps2 tends to decrease. On the other hand, in the process of the S200, for example, the controller 100 determines that the PM is not burned at present when the first accumulation amount Ps or the second accumulation amount Ps2 does not tend to decrease.

In the process of S200, when it is determined that PM is currently burned (S100: YES), the controller 100 executes a process of subtracting a predetermined value A from the current value of the accumulation density counter Cd (S210). A lower limit value is set for the accumulation density counter Cd. For example, the lower limit value is 0. When the value of the accumulation density counter Cd after the subtraction in the process of S210 is smaller than the lower limit value, the controller 100 performs the lower limit guard of the accumulation density counter Cd by substituting the lower limit value into the accumulation density counter Cd.

On the other hand, in the process of S200, when it is determined that PM is not burned at present (S100: NO), the controller 100 executes a process of adding a predetermined value B to the current value of the accumulation density counter Cd (S220). When the PM discharge amount Pa is large, the amount of PM trapped in the GPF 18 increases as compared with the case where the PM discharge amount Pa is small. Therefore, the speed at which the degree of variation in the accumulation amount decreases increases. Therefore, when the PM discharge amount Pa is large, it is desirable to increase the increase speed of the accumulation density counter Cd compared to when the PM discharge amount Pa is small. Therefore, the controller 100 of the present embodiment variably sets the value B such that the value B increases as the PM discharge amount Pa increases. Incidentally, the value B may be a fixed value.

An upper limit value is set for the accumulation density counter Cd. For example, the upper limit value is a value of the accumulation density counter Cd when the accumulation amount of PM along the exhaust flow direction of the GPF 18 is uniform and the degree of variation in the accumulation amount is smallest. Such an upper limit value is set to an appropriate value through a test in advance, for example. When the value of the accumulation density counter Cd after the addition in the process of S220 is larger than the upper limit value, the controller 100 performs the upper limit guard of the accumulation density counter Cd by substituting the upper limit value into the accumulation density counter Cd.

When either the process of S210 or the process of S220 is terminated, the controller 100 terminates the execution of the present process in the current cycle.

### PM Accumulation Amount Selection Process

The controller 100 executes a selection process of selecting one of the first accumulation amount Ps1 and the second accumulation amount Ps2 as the PM accumulation amount for control.

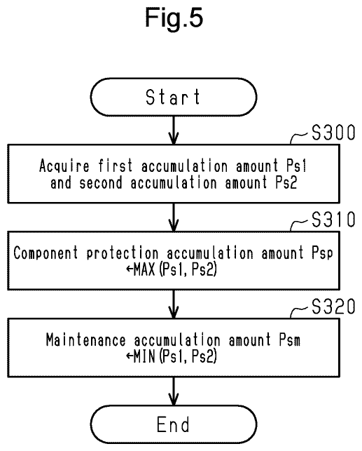

FIG. 5 shows a procedure of the selection process executed by the controller 100. The series of processes shown in FIG. 5 is realized by the CPU 110 executing a program stored in the memory 120 of the controller 100 at predetermined intervals.

In the series of processes shown in FIG. 5, the controller 100 first acquires the currently calculated first accumulation amount Ps1 and the currently calculated second accumulation amount Ps2 (S300).

If the process of S300 has been executed, next the controller 100 executes the process of S310.

In the process of S310, the controller 100 substitutes the accumulation amount having a larger value of the first accumulation amount Ps1 and the second accumulation amount Ps2 for the component protection accumulation amount Psp. The component protection accumulation amount Psp is a PM accumulation amount that is referred to when the above-described component protection control of the exhaust system is performed. Therefore, in the component protection control of the exhaust system, the component protection accumulation amount Psp is compared with the protection determination value C.

If process of S310 has been executed, next the controller 100 executes the process of S320.

In the process of S320, the controller 100 substitutes the accumulation amount having a smaller value of the first accumulation amount Ps1 and the second accumulation amount Ps2 for the maintenance accumulation amount Psm. The maintenance accumulation amount Psm is a PM accumulation amount referred to when the above-described maintenance control is performed. Therefore, in the maintenance control, the maintenance accumulation amount Psm is compared with the regeneration determination value A. Further, in the maintenance control, the maintenance accumulation amount Psm is compared with the excessive accumulation determination value B.

When the process of the S320 ends, the controller 100 ends the execution of the process in the current cycle.

### Operation and Advantages of the Present Embodiment

(1) The controller 100 executes an accumulation amount calculation process of calculating a first accumulation amount Ps1, which is the accumulation amount of PM accumulated in the GPF 18, based on the differential pressure AP, which is the pressure information. The accumulation amount calculation process includes correcting the first accumulation amount Ps1 in accordance with the degree of variation in the PM accumulation amount along the exhaust flow direction of the GPF 18.

The relationship between the differential pressure AP and the PM accumulation amount tends to change in accordance with the degree of variation in the accumulation amount of PM along the exhaust flow direction of the GPF 18. Therefore, the controller 100 of the present embodiment executes a process of correcting the first accumulation amount Ps1 calculated based on the differential pressure AP, which is the pressure information, in accordance with the degree of variation in the accumulation amount of PM along the exhaust flow direction of the GPF 18. Therefore, it is possible to accurately calculate the first accumulation amount Ps1 calculated based on the differential pressure AP, compared to a case where the first accumulation amount Ps1 is calculated without considering the degree of variation in the accumulation amount.

(2) The accumulation amount calculation process includes correcting the first accumulation amount Ps1 such that the first accumulation amount Ps1 is larger when the degree of variation in the accumulation amount is large than when the degree of variation in the accumulation amount is small.

Even if the actual PM accumulation amount in the GPF 18 is the same, when the degree of variation in the accumulation amount is large, the differential pressure AP tends to be smaller than when the variation is small. Therefore, when the degree of variation in the accumulation amount is large, the calculated first accumulation amount Ps1 tends to be smaller than the actual accumulation amount as compared with the case where the variation is small. Therefore, in the present embodiment, when the degree of variation in the accumulation amount is large, the first accumulation amount Ps1 is corrected so as to become larger compared with when the degree of variation in the accumulation amount is small. Therefore, the first accumulation amount Ps1 can be appropriately calculated in accordance with the degree of variation in the accumulation amount.

(3) The controller 100 executes an index value calculation process for calculating the accumulation density counter Cd, which is an index value indicating the degree of variation in the accumulation amount. The index value calculation process includes updating the value of the accumulation density counter Cd so as to indicate that the degree of variation in the accumulation amount increases when PM is burned. Further, the index value calculation process includes updating the value of the accumulation density counter Cd so as to indicate that the degree of variation in the accumulation amount decreases when the PM is not burned.

When oxygen supply by fuel cut is started to the GPF 18 heated to a high temperature, the PM is burned in the upstream portion of the GPF 18. On the other hand, since oxygen is consumed by the burning in the upstream portion, the burning of the PM is less likely to proceed in the downstream portion of the GPF 18. Therefore, when the PM is burned, the degree of variation in the amount of accumulation of the PM along the exhaust flow direction of the GPF 18 tends to increase. On the other hand, when the PM is not burned, the PM discharged from the combustion chamber is collected in the GPF 18, so the degree of variation in the amount of accumulation of the PM along the direction of flow of the exhaust gas in the GPF 18 tends to become smaller.

Therefore, in the present embodiment, a accumulation density counter Cd, which is an index value relating to the degree of variation in the accumulation amount, is calculated. When the value of the accumulation density counter Cd is small, the degree of variation in the accumulation amount is larger than when the value of the accumulation density counter Cd is large.

Then, as described above, when the PM burns, the degree of variation in the accumulation amount increases, and thus the value of the accumulation density counter Cd is updated so as to indicate that the degree of variation in the accumulation amount increases. That is, when the PM is burned, the value of the accumulation density counter Cd is updated to be smaller. On the other hand, when the PM is not burned, the degree of variation in the accumulation amount becomes small, and thus the value of the accumulation density counter Cd is updated so as to indicate that the degree of variation becomes small. That is, when the PM is not burned, the value of the accumulation density counter Cd is updated to be larger. Therefore, it is possible to appropriately calculate the index value indicating the degree of variation in the accumulation amount.

(4) The controller 100 executes the process of acquiring the first accumulation amount Ps1 calculated based on the differential pressure AP and the second accumulation amount Ps2 calculated based on the operation state of the internal combustion engine 10 (the process of S300 shown in FIG. 5). Then, the controller 100 executes a process of substituting the accumulation amount having a larger value between the first accumulation amount Ps1 and the second accumulation amount Ps2 into the component protection accumulation amount Psp (the process of S310 shown in FIG. 5). Then, the controller 100 performs the component protection control of the exhaust system using the component protection accumulation amount Psp.

Therefore, it is possible to appropriately perform the component protection control of the exhaust system as compared with the case where the smaller one of the first accumulation amount Ps1 and the second accumulation amount Ps2 is substituted for the component protection accumulation amount Psp.

For example, in the present embodiment, when the component protection accumulation amount Psp becomes equal to or larger than the protection determination value C, the excessive temperature rise suppression control for suppressing the excessive temperature rise of the GPF 18 is performed. When the component protection accumulation amount Psp is large, the opportunity for the component protection accumulation amount Psp to become equal to or larger than the protection determination value C increases, as compared with the case where the component protection accumulation amount Psp is small. Therefore, since the opportunity to execute the excessive temperature rise suppression control increases, the excessive temperature rise of the GPF 18 is appropriately suppressed.

(5) The controller 100 executes the process of acquiring the first accumulation amount Ps1 calculated based on the differential pressure AP and the second accumulation amount Ps2 calculated based on the operation state of the internal combustion engine 10 (the process of S300 shown in FIG. 5). Then, the controller 100 executes a process of substituting the accumulation amount having a smaller value of the first accumulation amount Ps1 and the second accumulation amount Ps2 for the maintenance accumulation amount Psm (the process of S320 shown in FIG. 5). Then, the controller 100 performs the maintenance control using the maintenance accumulation amount Psm.

Therefore, it is possible to appropriately perform the maintenance control compared to a case where the accumulation amount having a larger value of the first accumulation amount Ps1 and the second accumulation amount Ps2 is substituted into the maintenance accumulation amount Psm.

For example, in the present embodiment, when the maintenance accumulation amount Psm becomes equal to or larger than the above-mentioned recovery determination value A, the recovery control of the GPF 18 is performed. When the maintenance accumulation amount Psm is small, the opportunity for the maintenance accumulation amount Psm to become equal to or greater than the regeneration determination value A decreases compared to when the maintenance accumulation amount Psm is large. Therefore, since the opportunity to execute the regeneration control is reduced, it is possible to suppress frequent execution of the regeneration control.

Further, for example, in the present embodiment, since the above-described notification control is performed, when the maintenance accumulation amount Psm becomes equal to or larger than the above-described excessive accumulation determination value B, a warning for prompting maintenance in a repair shop to burn and remove the PM accumulated on the GPF 18 is issued. When the maintenance accumulation amount Psm is small, the opportunity for the maintenance accumulation amount Psm to become equal to or greater than the excessive accumulation determination value B decreases as compared to when the maintenance accumulation amount Psm is large. Therefore, since the number of times of notification of a warning is reduced, it is possible to suppress frequent notification of a warning.

### Modifications

The above-described embodiment may be modified as follows. The above-described embodiment and the following modifications can be combined if the combined modifications remain technically consistent with each other.

In the process of S200 shown in FIG. 4, it is determined whether PM is burned based on the tendency of change in the first accumulation amount Ps 1 or the second accumulation amount Ps2, but it may be determined whether PM is burned by another method. For example, when the PM burn-off amount Pb is larger than 0, it may be determined that the PM is being burned. Further, for example, it may be determined whether the PM is burned based on the engine rotation speed NE and the engine load factor.

In the above embodiment, when the value of the accumulation density counter Cd is small, the degree of variation in the accumulation amount is larger than when the value of the accumulation density counter Cd is large. Conversely, when the value of the accumulation density counter Cd is small, the degree of variation in the accumulation amount may be indicated to be smaller than when the value of the accumulation density counter Cd is large. In the case of this modified example, the value of the correction factor K is variably set so that the value of the correction factor K becomes a smaller value as the value of the accumulation density counter Cd becomes smaller, whereby the same effect as in the above-mentioned embodiment can be obtained.

The pressure information is the differential pressure AP between the exhaust gas pressure EP upstream of the GPF 18 and the atmosphere pressure. Alternatively, the pressure information may be a differential pressure between the exhaust gas pressure EP upstream of the GPF 18 and the exhaust gas pressure downstream of the GPF 18.

The second accumulation amount Ps2 may be calculated in a manner different from the above embodiment.

The position of the GPF 18 in the exhaust passage 15 may be changed as appropriate.

The GPF 18 may be a filter that does not carry a three-way catalyst.

The controller 100 is not limited to a device that includes a CPU and a memory module and executes software processing. For example, the controller 100 may include hardware circuits, for example, an application-specific integrated circuit (ASIC), dedicated to executing at least part of the processes executed by the software in the above-described embodiment. That is, the controller 100 may be modified as long as it includes processing circuitry that has any one of the following configurations (a) to (c). (a) Processing circuitry including at least one processor that executes all of the above-described processes according to programs and at least one program storage device such as a ROM that stores the programs. (b) Processing circuitry including at least one processor and at least one program storage device that execute part of the above-described processes according to the programs and at least one dedicated hardware circuit that executes the remaining processes. (c) Processing circuitry including at least dedicated hardware circuit that executes all of the above-described processes. Program storage devices, or computer-readable storage media, include any available storage media that can be accessed by a general purpose or special purpose computer.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A controller configured to control an internal combustion engine, the internal combustion engine including a filter that is provided in an exhaust passage and traps particulate matter in an exhaust gas, and a pressure sensor that detects pressure information including a pressure on an exhaust upstream side of the filter, the controller comprising processing circuitry, wherein
the processing circuitry is configured to execute an accumulation amount calculation process of calculating an accumulation amount of the particulate matter accumulated in the filter based on the pressure information, and
the accumulation amount calculation process includes correcting the accumulation amount in accordance with a degree of variation in the accumulation amount of the particulate matter along an exhaust flow direction of the filter.

2. The controller for the internal combustion engine according to claim 1, wherein the accumulation amount calculation process includes correcting the accumulation amount such that the accumulation amount is larger when the degree of variation is relatively large than when the degree of variation is relatively small.

3. The controller for the internal combustion engine according to claim 1, wherein
the processing circuitry is configured to execute an index value calculation process that calculates an index value indicating the degree of variation, and
the index value calculation process includes:
updating the index value so as to indicate that the degree of variation increases when the particulate matter is being burned; and
updating the index value so as to indicate that the degree of variation decreases when the particulate matter is not being burned.

4. The controller for the internal combustion engine according to claim 1, wherein the processing circuitry is configured to
acquire the accumulation amount calculated based on the pressure information as a first accumulation amount;
acquire a second accumulation amount that is an accumulation amount of particulate matter accumulated in the filter, the second accumulation amount being calculated based on an operation state of the internal combustion engine; and
perform a component protection control for the exhaust system using a larger one of the first accumulation amount and the second accumulation amount.

5. The controller for the internal combustion engine according to claim 1, wherein the processing circuitry is configured to
acquire the accumulation amount calculated based on the pressure information as a first accumulation amount;
acquire a second accumulation amount that is an accumulation amount of particulate matter accumulated in the filter, the second accumulation amount being calculated based on an operation state of the internal combustion engine; and
perform a maintenance control for the filter using a smaller one of the first accumulation amount and the second accumulation amount.
